(19) United States
(12) Patent Application Publication
(10) Pub. No.: US 2016/0101478 A1
(43) Pub. Date: Apr. 14, 2016

(54) Pipe Cutter

(71) Applicant: Min Tang, Huizhou (CN)

(72) Inventor: Min Tang, Huizhou (CN)

(21) Appl. No.: 14/975,759

(22) Filed: Dec. 19, 2015

Related U.S. Application Data
(63) Continuation-in-part of application No. PCT/CN2014/082789, filed on Jul. 23, 2014.

(30) Foreign Application Priority Data
Jul. 23, 2013 (CN) 201320441632.2

(51) Int. Cl. B23D 47/12; B23D 47/10; B23D 45/12

(52) U.S. Cl. CPC B23D 47/12; B23D 45/12; B23D 47/10

(57) ABSTRACT

A pipe cutter comprises a rack (100), a power unit (110), a pushing device (120), a transmission device (130) and a cutting device (140), wherein the pushing device (120) is arranged on the rack (100); the cutting device (140) is connected to the output end of the transmission device (130); the transmission device (130) is rotatably installed on the rack (100); the transmission device comprises at least two gears mutually engaged; the power unit (110) is connected to the input end of the transmission device (130); the power unit (110) can drive the cutting device through the transmission device; and the pushing device (120) is connected with the transmission device (130), and can push the cutting device (140) to move through the transmission device (130) for realizing cutting. Compared with the prior art, without installing a sliding rail for the power unit to slide, the power unit does not need to move during operation, so that the present invention has the advantages of simple structure, reliable operation and difficult damage.

### CROSS-REFERENCE TO RELATED APPLICATIONS

This application is a continuation-in-part of International Patent Application No. PCT/CN2014/082789 with an international filing date of Jul. 23, 2014, designating the United States, now pending, and further claims priority benefits to Chinese Patent Application No. 201320441632.2 filed Jul. 23, 2013. The contents of all of the aforementioned applications, including any intervening amendments thereto, are incorporated herein by reference.

### TECHNICAL FIELD

The present invention relates to the technical field of processing of tubular material, in particular to a device for cutting the tubular material.

### BACKGROUND OF THE PRESENT INVENTION

In the processing industry of pipes, particularly metal pipes, the pipes are often required to be cut according to certain size requirements. This simple and repeated work is completely finished by manual cutting in early stage. Although the cost is low, the cutting efficiency is not high; the size is not accurately grasped; and the rate of finished products is not high. Subsequently, a device specially used for cutting the pipes appears on the market, i.e., a pipe cutter.

The pipe cutter provided in the prior art generally comprises a rack, a motor, a warm and gear, a saw blade and an oil cylinder, wherein the motor is installed on the rack; one end of the warm and gear is connected with the output end of the motor; and the other end is connected with the saw blade. During operation, the motor drives the saw blade to rotate while realizing deceleration through the transmission of the warm and gear. The oil cylinder pushes the pipe to be cut towards the saw blade with certain stress so as to realize cutting of the pipe. The defect of the product is very obvious. When the saw blade cannot smoothly cut the pipe, it is easy to damage the saw blade by the cutting mode of pushing the pipe towards the saw blade with certain stress.

With respect to this, the prior art also provides another pipe cutter. The pipe cutter changes the mode of pushing the pipe by the oil cylinder for cutting, but pushes the motor, the worm and gear and the saw blade by the oil cylinder to move together towards the saw blade so as to realize cutting. Although the pipe cutter solves the problem of easy damage of the saw blade, a sliding rail for the motor and the worm and gear to slide shall be arranged on the rack; during cutting, the motor shall also be pushed; and the pipe cutter has the defects of complicated structure, easy damage of the sliding rail and the motor, low transmission efficacy of the worm and gear, etc.

### DISCLOSURE OF THE PRESENT INVENTION

### Technical Problem

A technical problem to be solved by the present invention is to provide a pipe cutter with simple structure, reliable work and durability.

### SOLUTION TO THE PROBLEM

### Technical Solution

To solve the above technical problem, the present invention adopts the technical solution that:

A pipe cutter comprises a rack, a power unit, a pushing device, a transmission device and a cutting device, wherein the pushing device is arranged on the rack; the cutting device is connected to the output end of the transmission device; the transmission device is rotatably installed on the rack; the transmission device comprises at least two gears mutually engaged; the power unit is connected to the input end of the transmission device; the power unit can drive the cutting device through the transmission device; and the pushing device is connected with the transmission device, and can push the cutting device to move through the transmission device for realizing cutting.

Further preferably, the pipe cutter also comprises a one-way bearing; and the power unit drives the transmission device and the cutting device through the one-way bearing, so that only one-way transmission is allowed between the power unit and the transmission device. When a pipe is cut, generated counterforce will not act on the cutting device, but is absorbed by the one-way bearing, so that the cutting device does not simultaneously bear positive acting force and negative acting force. Compared with the prior art, the present invention greatly alleviates the pressure of the cutting device, and effectively prolongs the service life of the cutting device.

As an improvement on the above optimization, the transmission device comprises a cabinet and a transmission shaft; the one-way bearing comprises an outer ring and an inner ring; the inner ring is sleeved on the transmission shaft; and the outer ring is firmly cooperated with the cabinet. Although the transmission shaft can be the output shaft of the power unit or a transmission shaft in the transmission device between the power unit and the cutting device, the effect of the latter is better than that of the former. During cutting, the inner ring rotates with the transmission shaft. When the counterforce occurs, the friction between the outer ring and the cabinet offsets the counterforce transferred to the inner ring by the transmission shaft.

As an improvement, the power unit is fixedly connected to the rack; and the pushing device can push the cutting device to move relative to the power unit.

Alternatively, an installing shaft is arranged on the rack; the transmission device is rotatably sleeved on the installing shaft; the power unit is fixedly connected to the transmission device, and the pushing device can simultaneously push the transmission device and the power unit.

As a further optimization of the above improvement, the power unit comprises a motor and a decelerator; one end of the decelerator is connected with the motor; the other end is provided with an output shaft; and the output end is connected with the transmission device.

As an improvement on the above optimization, the transmission device comprises a first transmission gear, a second transmission gear and a third transmission gear, wherein the first transmission gear is installed on the output shaft of the decelerator; the second transmission gear and the third transmission gear are respectively engaged with the first transmission gear and the second transmission gear; the relative positions among the first transmission gear, the second transmission gear and the third transmission gear are fixed; and the cutting device is installed on the gear shaft of the third transmission gear. Using the combination of the three gears can reduce the size of the gears, thereby reducing the influence on the operation of the cutting device.

As a further improvement on the above improvement, the transmission device also comprises a fixing plate; the fixing plate is connected to both ends of the gear shafts of the first transmission gear, the second transmission gear and the third transmission gear; and the pushing device is connected with the fixing plate and can push the cutting device to rotate around the output shaft of the decelerator.

As a further improvement on the above improvement, a pushing gear is arranged on the fixing plate; a rack is connected to the pushing device; and the rack is engaged with the pushing gear. In this way, the rack is driven and the gears are pushed so that the cutting device rotates to finish cutting.

As a second further optimization of the above improvement, the transmission device comprises a first transmission gear, a second transmission gear and a third transmission gear, wherein the first transmission gear is installed on the output shaft of the decelerator; the second transmission gear and the third transmission gear are respectively engaged with the first transmission gear and the second transmission gear; the relative positions among the first transmission gear, the second transmission gear and the third transmission gear are changeable; and the cutting device is installed on the gear shaft of the third transmission gear. Because the relative positions among the first transmission gear, the second transmission gear and the third transmission gear are changeable, the gear shaft of the third transmission gear and the cutting device can realize translation.

As a further improvement on the above improvement, the transmission device also comprises a first swinging mechanism and a second swinging mechanism; the first swinging mechanism is respectively connected with the gear shafts of the first transmission gear and the second transmission gear; and the second swinging mechanism is respectively connected with the gear shafts of the second transmission gear and the third transmission gear.

As a further improvement on the above improvement, the transmission device also comprises a fixing plate; the first swinging mechanism and the second swinging mechanism comprise two swinging sheets; the fixing plate is installed on the rack in a sliding way and is sleeved on both ends of the gear shaft of the third transmission gear; two swinging sheets of the first swinging mechanism are respectively sleeved on both ends of the gear shafts of the first transmission gear and the second transmission gear; and two swinging sheets of the second swinging mechanism are respectively sleeved on both ends of the gear shafts of the second transmission gear and the third transmission gear. In this way, the swinging sheets swing to realize the translation of the gear shaft of the third transmission gear and the cutting device.

By reading and referring to the description of the following drawings and specific embodiments, it is easier to understand and grasp the characteristics of the present invention.

### BENEFICIAL EFFECTS OF THE PRESENT INVENTION

### Beneficial Effects

After such structure is adopted, during cutting, the power unit can be fixedly arranged on the rack, while the pushing device can push the transmission device so as to push the cutting device to cut the pipe to be processed. Compared with the prior art, there is no need to install a sliding rail for the power unit to slide. Moreover, a gear set is used for replacing warms and gears so that the present invention has the advantages of simple structure, reliable operation and difficult damage.

### BRIEF DESCRIPTION OF THE DRAWINGS

### Description of the Drawings

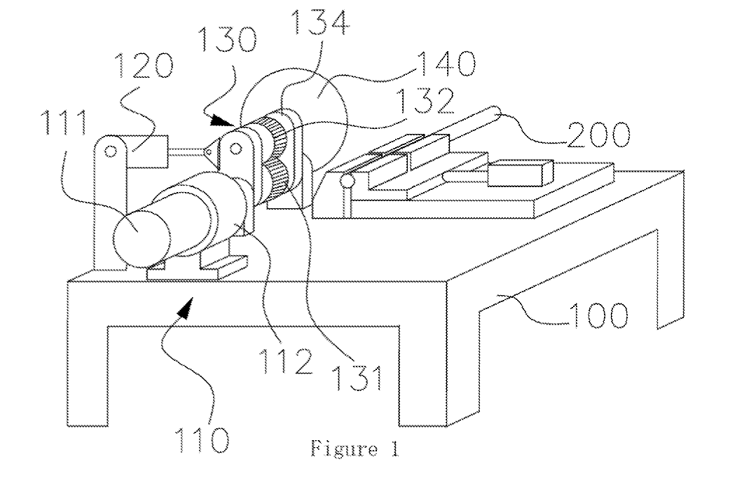

FIG. 1 is a partial structural diagram embodiment provided by the present invention;

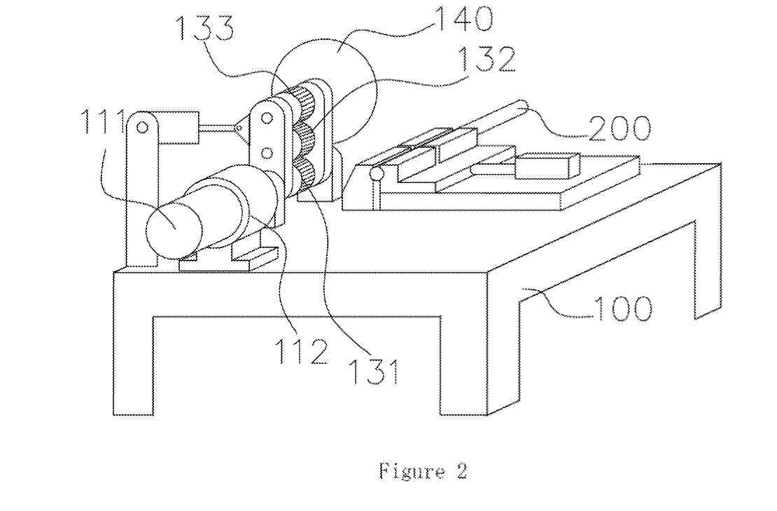

FIG. 2 is a structural diagram of a further improvement on the first embodiment;

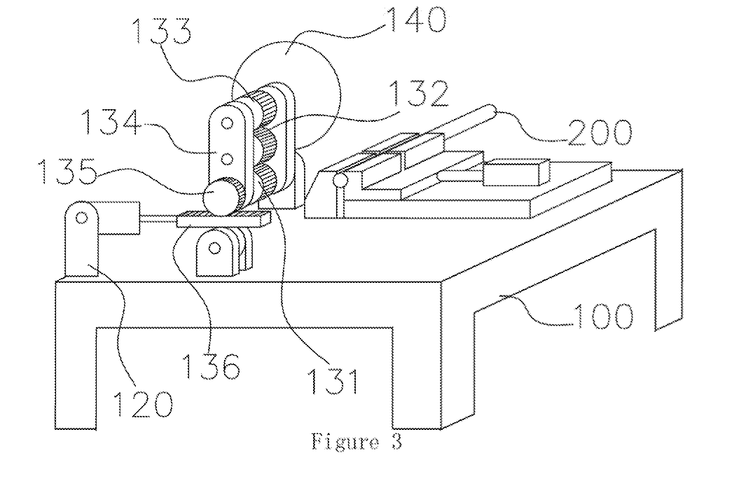

FIG. 3 is a local structural diagram of a further improvement on the first embodiment;

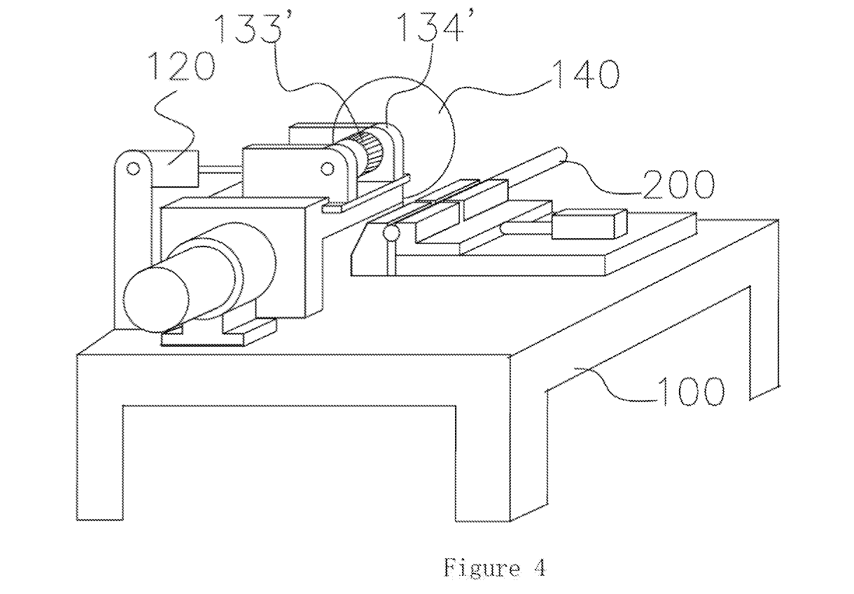

FIG. 4 is a partial structural diagram of a second embodiment provided by the present invention;

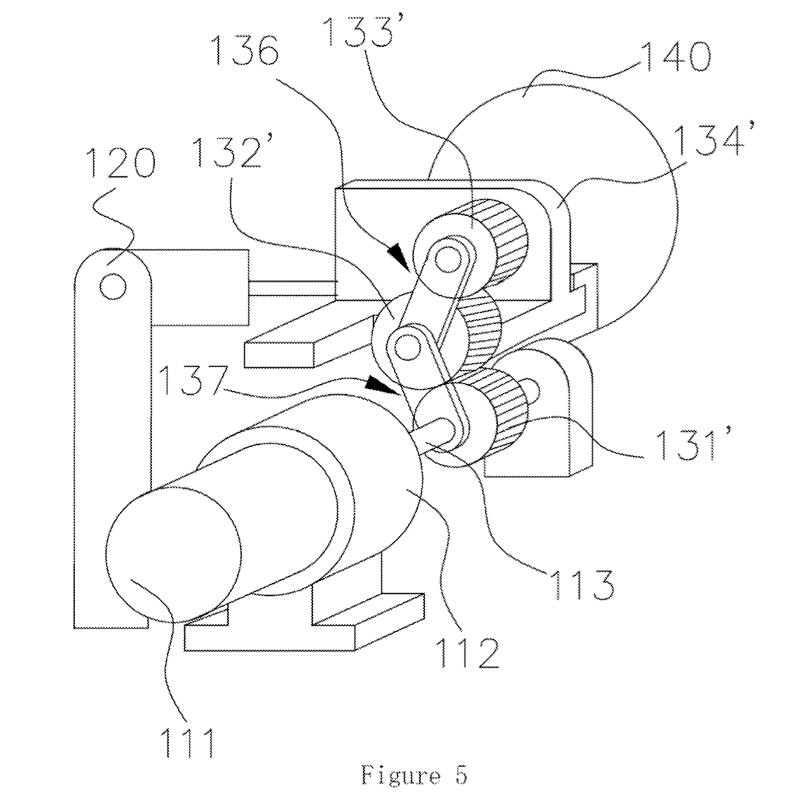

FIG. 5 is a local internal structural diagram in FIG. 4;

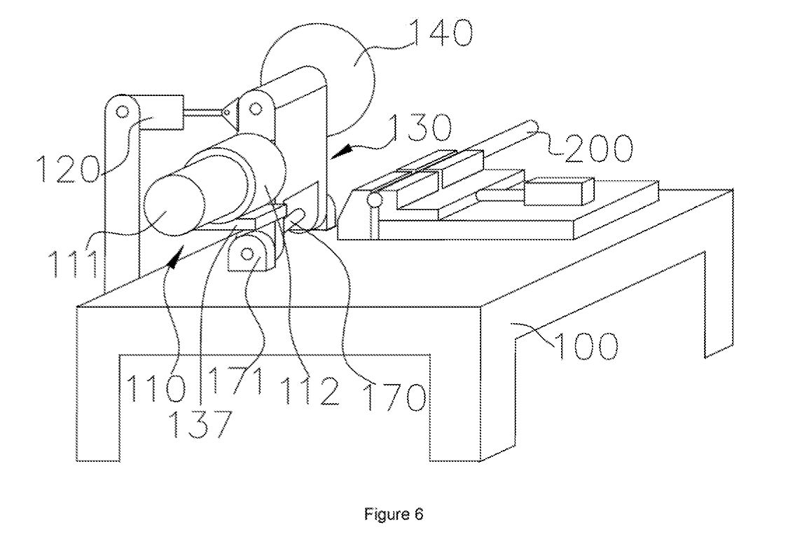

FIG. 6 is a partial structural diagram of a third embodiment provided by the present invention;

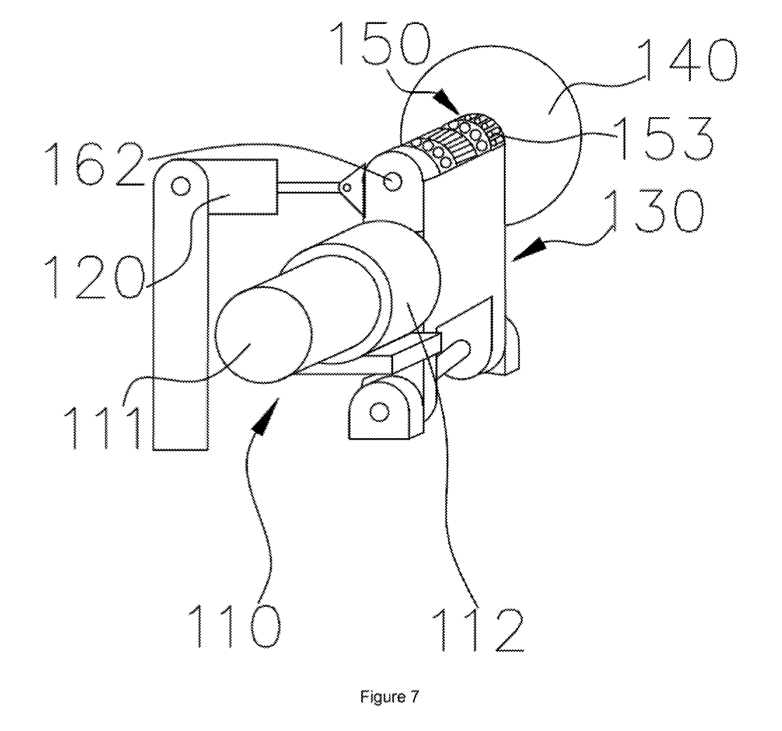

FIG. 7 is a structural diagram of a second improvement on the first embodiment provided by the present invention; and

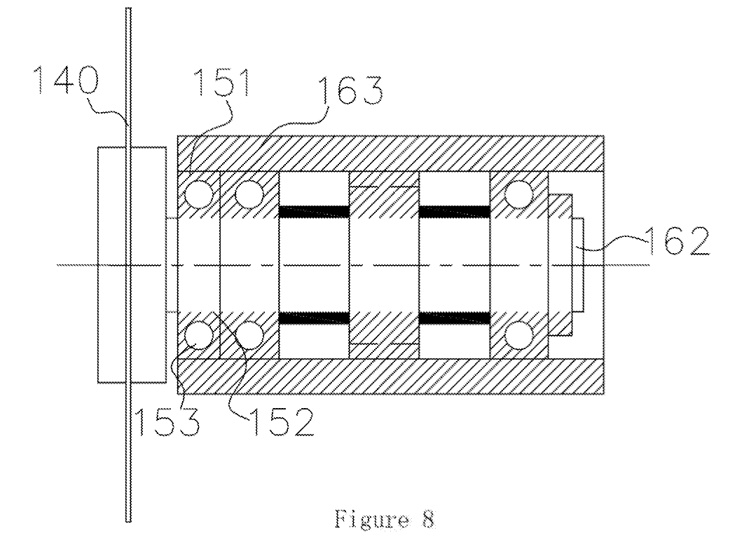

FIG. 8 is a local structural sectional diagram of FIG. 7.

### EMBODIMENTS OF THE INVENTION

### Embodiments Of The Present Invention

To ensure that the technical problem to be solved by the present invention, the technical solution and the advantages are clearer, the present invention is further described in detail below with the combination of the drawings and the embodiments. It should be appreciated that the specific embodiments described herein are only used for explaining the present invention, not for limiting the present invention.

All the drawings only reveal the parts closely related to the present invention, but not all structures of the pipe cutter. FIG. 1 to FIG. 3 show a pipe cutter in the first embodiment of the present invention. As shown in the drawings, the pipe cutter comprises a rack 100, a power unit 110, a pushing device 120, a transmission device 130 and a cutting device 140, wherein the power unit 110 and the pushing device 120 are arranged on the rack 100. During operation, the power unit 110 is fixed to the rack 100.

The power unit 110 can be selected according to the actual demand in the prior art, such as electric motor, pneumatic motor, etc. Specifically, the power unit 110 of the embodiment comprises a motor 111 and a decelerator 112; one end of the decelerator 112 is connected with the motor 111; the other end is connected with the transmission device 130; and the decelerator 112 can also be selected in the prior art. The cutting device 140 is connected to the transmission device 130 and can be driven by the transmission device 130. In the embodiment, the cutting device 140 is a saw blade. The transmission device 130 is movably connected with the power unit 110. Specifically, the transmission device 130 is connected with the decelerator 112. So-called “movable” connection means that during operation, the transmission device 130 not only can transmit the rotating force of the power unit 110, but also can simultaneously move in a relative position. The pushing device 120 is connected with the transmission device 130 and can push the transmission device 130, so that the cutting device 140 connected to the transmission device 130 moves relative to the power unit 110.

In this way, during cutting operation, the power unit 110 can be fixedly arranged on the rack 100, while the pushing device 120 can push the transmission device 130, so as to push the cutting device 140 to move towards the pipe 200 to be processed until the pipe 200 is cut. The pipe 200 can be made of metal or non-metal. The section of the pipe 200 can be circular or square or polygonal. Compared with the prior art, because there is no need to install a sliding rail in the embodiment for the power unit 110 to slide and the power unit 110 does not need to move during operation, the present invention has the advantages of simple structure, reliable operation and difficult damage.

As a first further optimization of the above improvement, mainly referring to FIG. 1, the transmission device 130 comprises at least two gears, and comprises two gears in the optimization, i.e., a first transmission gear 131 and a second transmission gear 132. The decelerator 112 comprises an output shaft 113 (also referring to FIG. 5 please). The first transmission gear 131 is installed on the output shaft 113 of the decelerator 112, namely that the output shaft 113 is used as a gear shaft of the first transmission gear 131. The second transmission gear 132 is engaged with the first transmission gear 131. The cutting device 140 is installed on the gear shaft of the second transmission gear 132 and can rotate with the gear shaft, while the pushing device 120 can push the cutting device 140 to rotate relative to the power unit 110 so as to move towards the pipe 200 to be processed in a rotating manner until the pipe 200 is cut. The structure uses ordinary gear set transmission to replace a traditional warm and gear transmission structure, can obviously increase the transmission efficiency and is not easy to damage.

Because the combination of the two gears requires large size of the gears, otherwise the sawable scope of the cutter may be affected, as an improvement on the above optimization, referring to FIG. 2, three transmission gears can be selected as the transmission device 130, i.e., comprising a first transmission gear 131, a second transmission gear 132 and a third transmission gear 133. The first transmission gear 131 is installed on the output shaft 113 of the decelerator 112, namely that the output shaft 113 of the decelerator 112 is used as the gear shaft thereof. The second transmission gear 132 is engaged with the first transmission gear 131. The third transmission gear 133 is engaged with the second transmission gear 132. The relative positions among the first transmission gear 131, the second transmission gear 132 and the third transmission gear 133 are fixed. In other words, the three transmission gears rotate together and do not relatively move. The cutting device 140 is installed on the gear shaft of the third transmission gear 133 and can rotate with the gear shaft. Using the combination of the three gears can reduce the size of the gears, thereby reducing the influence on the operation of the cutting device 140.

As a further improvement on the above improvement, the transmission device 130 also comprises a fixing plate 134. The fixing plate 134 is connected to both ends of the gear shafts of the first transmission gear 131, the second transmission gear 132 and the third transmission gear 133. Specifically, the structure of the fixing plate 134 can be selected according to the prior art. For example, two plates can be respectively installed on both ends of the gear shafts of the three transmission gears; or the fixing plate can be a box body and the three transmission gears are put therein; and both ends of the gear shaft are respectively installed on two side plates of the box body. The pushing device 120 is connected with the fixing plate 134. Specifically, as shown in FIG. 1 and FIG. 2, an oil cylinder can be used as the pushing device 120. One end of the oil cylinder is rotatably installed on the rack 100, and the other end is movably connected with the fixing plate 134. In other words, when the oil cylinder pushes the fixing plate 134 to rotate, both ends of the oil cylinder can rotate therewith so as to finally achieve that the cutting device 140 is pushed to rotate around the output shaft 113 of the decelerator 112, i.e., the gear shaft of the first transmission gear 131.

As a further improvement on the above improvement, refer to FIG. 3 please. A pushing gear 135 is arranged on the fixing plate 134. Specifically, the improvement is that an independent gear is additionally installed fixedly on the fixing plate 134, the pushing gear 135 rotates and also drives the fixing plate 134 to rotate. Of course, alternatively, the corresponding position of the fixing plate 134 can also be processed into a gear (not shown in the drawing). To match with the gear, a rack 136 is connected to the pushing device 120, i.e., the oil cylinder. The rack 136 is engaged with the pushing gear 135. In this way, the rack 136 and the pushing gear 135 can be pushed through the oil cylinder so that the cutting device 140 rotates around the output shaft 113 of the decelerator 112, i.e., the gear shaft of the first transmission gear 131, to finish cutting.

FIG. 4 and FIG. 5 show a pipe cutter in the second embodiment of the present invention. Compared with the first embodiment, the difference is that; the transmission device 130 comprises at least three gears; and the pushing device 120 can push the cutting device 140 to translate relative to the power unit 110. So-called translation is relative to the rotation of the first embodiment, and can be linear movement not necessarily horizontal movement. In other words, the cutting device 140 of the embodiment, i.e., the saw blade, adopts a translation mode. In terms of FIG. 4, the cutting device 140 moves towards the pipe 200 to be processed in a horizontal movement mode, while the two gears cannot translate the cutting device 140. Therefore, the transmission device 130 in the embodiment at least has three gears.

More specifically, as shown in FIG. 5, the transmission device 130 comprises a first transmission gear 131′, a second transmission gear 132′ and a third transmission gear 133′. The first transmission gear 131 is installed on the output shaft 113 of the decelerator 112, and the second transmission gear 132′ is engaged with the first transmission gear 131′, while the third transmission gear 133′ is engaged with the second transmission gear 132′ to realize power transfer. To achieve the purpose that the gear shaft of the third transmission gear 133′ and the cutting device 140 translate, the relative positions among the first transmission gear 131′, the second transmission gear 132′ and the third transmission gear 133′ are changeable. The cutting device 140, i.e., the saw blade, is installed on the gear shaft of the third transmission gear 133′ and can rotate therewith.

As a further improvement, the transmission device 130 also comprises a first swinging mechanism 136 and a second swinging mechanism 137; the first swinging mechanism 136 is respectively connected with the gear shafts of the first transmission gear 131′ and the second transmission gear 132′; and the second swinging mechanism 137 is respectively connected with the gear shafts of the second transmission gear 132′ and the third transmission gear 133′. This can realize that the relative positions among the first transmission gear 131′, the second transmission gear 132′ and the third transmission gear 133′ are changeable.

More specifically, the transmission device 130 also comprises a fixing plate 134′; and the first swinging mechanism 136 and the second swinging mechanism 137 comprise two swinging sheets. Refer to FIG. 5 for the details (only one swinging sheet is shown in the drawing). The fixing plate 134′ is installed on the rack 100 in a sliding way and is sleeved on both ends of the gear shaft of the third transmission gear 133′. Many solutions provided in the prior art can be adopted for installing the fixing plate 134′ on the rack 100 in a sliding way. For example, a sliding rail is arranged on the rack 100; the fixing plate 134′ can translate along the sliding rail; refer to FIG. 4; or a sliding seat can also be used to realize that. Two swinging sheets of the first swinging mechanism 136 are respectively sleeved on both ends of the gear shafts of the first transmission gear 131′ and the second transmission gear 132′; and the two swinging sheets of the second swinging mechanism 137 are respectively sleeved on both ends of the gear shafts of the second transmission gear 132′ and the third transmission gear 133′. In this way, the swinging sheets swing to realize the translation of the gear shaft of the third transmission gear 133′ and the cutting device 140.

FIG. 6 shows a pipe cutter in the third embodiment of the present invention. Compared with the first embodiment, the difference is that: an installing shaft 170 is arranged on the rack 100 and is installed through two brackets 171, while the transmission device 130 is sleeved on the installing shaft 170 and can rotate around the installing shaft 170. The power unit 110 is fixedly connected to the transmission device 130. Specifically, an installing plate 137 is arranged on the transmission device 130, and the power unit 110 is fixedly connected to the installing plate 137.

Because the power unit 110 is fixedly connected with the transmission device 130, for achieving the purpose of pushing the cutting device, the pushing device 160 not only can directly push the transmission device 130, but also can indirectly push the transmission device 130 by pushing the power unit 110. Preferably, in the embodiment, the pushing device 160 is directly connected with the transmission device 130, namely directly pushes the transmission device 130. Of course, pushing device 160 also pushes power unit 110, and finally pushes the cutting device 140 to move to realize cutting.

FIG. 7 and FIG. 8 show the second improvement of the first embodiment of the present invention. The pipe cutter also comprises a one-way bearing 150. After the power unit 110 outputs power, the power first passes through the one-way bearing 150, and then drives the transmission device 130 and the cutting device 140. The improvement causes that when the pipe is cut, generated counterforce will not act on the cutting device 140, but is absorbed by the one-way bearing 150, so that the cutting device 140 does not simultaneously bear positive acting force and negative acting force. Compared with the prior art, the present invention greatly alleviates the pressure of the cutting device 140, and effectively prolongs the service life of the cutting device 140.

As a further optimization of the above solution, then transmission device 130 comprises a cabinet 163 and a transmission shaft 162; the one-way bearing 150 comprises an outer ring 151 and an inner ring 152 (please refer to FIG. 8); and a roller 153 is arranged between the inner ring 152 and the outer ring 151 (please refer to FIG. 7).

When not assembled, the inner ring 152 can drive the outer ring 151 in a certain direction to rotate through the action of the roller 153, while in an opposite direction, the inner ring 152 can idle and the outer ring 151 does not rotate therewith. During installation, the inner ring 152 is sleeved on the transmission shaft 162; the outer ring 151 is firmly cooperated with the cabinet 133; the inner ring 152 is ensured to idle without interference from the outer ring 151 when the saw blade rotatably cuts the pipe; but when the saw blade rotates in an opposite direction, the outer ring 151 can restrain the rotation of the inner ring 152. In this way, during cutting operation, the inner ring 152 rotates with the transmission shaft 162 without an influence from the outer ring 151; and when the counterforce occurs, the friction between the outer ring 151 and the cabinet 133 offsets the counterforce transferred to the inner ring 152 by the transmission shaft 162. Although the one-way bearing 150 can be directly installed on the output shaft of the power unit 110, the effect is not as good as that of being installed on the transmission shaft in the transmission device 130. Of course, the effect of being installed on the transmission shaft connected with the cutting device is better.

The mentioned above is preferred embodiments of the present invention, not used for limiting the present invention. Any modification, equivalent replacement and improvement made within the spirit and the principle of the present invention shall be contained within the protection scope of the present invention.

1, A pipe cutter, comprising a rack, a power unit, a pushing device, a transmission device and a cutting device, wherein the pushing device is arranged on the rack and the cutting device is connected to the output end of the transmission device, characterized in that: the transmission device is rotatably installed on the rack, the transmission device comprises at least two gears mutually engaged; the power unit is connected to the input end of the transmission device; the power unit can drive the cutting device through the transmission device; and the pushing device is connected with the transmission device, and can push the cutting device to move through the transmission device for realizing cutting.

2, The pipe cutter according to claim 1, characterized in that: the pipe cutter also comprises a one-way bearing; and the power unit drives the transmission device and the cutting device through the one-way bearing, so that only one-way transmission is allowed between the power unit and the transmission device.

3, The pipe cutter according to claim 2, characterized in that: the transmission device comprises a cabinet and a transmission shaft; the one-way bearing comprises an outer ring and an inner ring; the inner ring is sleeved on the transmission shaft; and the outer ring is firmly cooperated with the cabinet.

4, The pipe cutter according to claim 1, characterized in that: the power unit is fixedly connected to the rack; and the pushing device can push the cutting device to move relative to the power unit.

5, The pipe cutter according to claim 1, characterized in that: an installing shaft is arranged on the rack; the transmission device is rotatably sleeved on the installing shaft; the power unit is fixedly connected to the transmission device; and the pushing device can simultaneously push the transmission device and the power unit.

6, The pipe cutter according to claim 2, characterized in that: the power unit comprises a motor and a decelerator; one end of the decelerator is connected with the motor; the other end is provided with an output shaft; and the output end is connected with the transmission device.

7, The pipe cutter according to claim 4, characterized in that: the transmission device comprises a first transmission gear, a second transmission gear and a third transmission gear, wherein the first transmission gear is installed on the output shaft of the decelerator; the second transmission gear and the third transmission gear are respectively engaged with the first transmission gear and the second transmission gear; the relative positions among the first transmission gear, the second transmission gear and the third transmission gear are fixed; and the cutting device is installed on a gear shaft of the third transmission gear.

8, The pipe cutter according to claim 5, characterized in that: the transmission device also comprises a fixing plate; the fixing plate is connected to both ends of the gear shafts of the first transmission gear, the second transmission gear and the third transmission gear; and the pushing device is connected with the fixing plate and can push the cutting device to rotate around the output shaft of the decelerator.

9, The pipe cutter according to claim 6, characterized in that: a pushing gear arranged on the fixing plate; a rack is connected to the pushing device; and the rack is engaged with the pushing gear.

10, The pipe cutter according to claim 4, characterized in that: the transmission device comprises a first transmission gear, a second transmission gear and a third transmission gear, wherein the first transmission gear is installed on the output shaft of the decelerator; the second transmission gear and the third transmission gear are respectively engaged with the first transmission gear and the second transmission gear; the relative positions among the first transmission gear, the second transmission gear and the third transmission gear are changeable; and the cutting device is installed on the gear shaft of the third transmission gear.

11, The pipe cutter according to claim 8, characterized in that: the transmission device also comprises a first swinging mechanism and a second swinging mechanism; the first swinging mechanism is respectively connected with the gear shafts of the first transmission gear and the second transmission gear; and the second swinging mechanism is respectively connected with the gear shafts of the second transmission gear and the third transmission gear.

12, The pipe cutter according to claim 9, characterized in that: the transmission device also comprises a fixing plate; the first swinging mechanism and the second swinging mechanism comprise two swinging sheets; the fixing plate is installed on the rack in a sliding way and is sleeved on both ends of the gear shaft of the third transmission gear; the two swinging sheets of the first swinging mechanism are respectively sleeved on both ends of the gear shafts of the first transmission gear and the second transmission gear; and two swinging sheets of the second swinging mechanism are respectively sleeved on both ends of the gear shafts of the second transmission gear and the third transmission gear.

13, The pipe cutter according to claim 3, characterized in that: the power unit comprises a motor and a decelerator; one end of the decelerator is connected with the motor; the other end is provided with an output shaft; and the output end is connected with the transmission device.

14, The pipe cutter according to claim 13, characterized in that: a pushing gear is arranged on the fixing plate; a rack is connected to the pushing device; and the rack is engaged with the pushing gear.

15, The pipe cutter according to claim 14, characterized in that: the transmission device also comprises a fixing plate; the first swinging mechanism and the second swinging mechanism comprise two swinging sheets; the fixing plate is installed on the rack in a sliding way and is sleeved on both ends of the gear shaft of the third transmission gear; the two swinging sheets of the first swinging mechanism are respectively sleeved on both ends of the gear shafts of the first transmission gear and the second transmission gear; and two swinging sheets of the second swinging mechanism are respectively sleeved on both ends of the gear shafts of the second transmission gear and the third transmission gear.
